(19) United States
(12) Patent Application Publication
(10) Pub. No.: US 2011/0138022 A1
(43) Pub. Date: Jun. 9, 2011

(54) Fast Content Switching in a Communication System

(75) Inventors: Jinyang Xie, Shanghai (CN); Jie Ling, Shanghai (CN)

(73) Assignee: TELEFONAKTIEBOLAGET LM ERICSSON (PUBL), Stockholm (SE)

(21) Appl. No.: 13/058,454

(22) PCT Filed: Aug. 12, 2008
(86) PCT No.: PCT/CN2008/001454

§ 371 Date: Feb. 10, 2011

(51) Int. Cl. G06F 15/16

(52) U.S. Cl. 709/219

(57) ABSTRACT

The invention discloses a method for a media server initiating fast content switching in a communication network. The method comprises sending (S713, S730, S813, S830) a first message to a terminal (510) which is receiving or requesting a first content data, informing the terminal (510) a switching to a second content data. The method further comprises delivering (S714, S732, S814, S832) the second content data to the terminal (510).

### TECHNICAL FIELD

The present invention generally relates to fast content switching in a communication system, and more particularly, to a system and method for supporting content switching initiated from the media delivering side. Such content may for instance be advertisements.

### BACKGROUND

Mobile and/or wireless terminals such as mobile phone are becoming increasingly popular. In addition, many terminals support multimedia functions, such as video playback, audio playback, and image display. It has become a trend to offer and provide a vast range of multimedia services so that the users may enjoy multimedia content on their terminals.

The multimedia service using streaming over Internet Protocol (IP) based networks can be implemented into existing mobile networks. An example is the 3rd Generation Partnership Project (3GPP) Packet-Switched Streaming Service (PSS), which is a standard for media streaming to handheld mobile terminals and provides a complete streaming and download framework for commercial content. Typically, the terminal, also referred to as client, establishes a Real Time Streaming Protocol (RTSP) session with a media server according to the user's input, and plays the media or multimedia content delivered by the media server. The RTSP, which is developed by the IETF and created in 1998 as RFC 2326, is a protocol for use in streaming media systems which allows a client to remotely control a media server, issuing VCR-like commands such as “play” and “pause”, and allowing time-based access to files on the media server.

3GPP Release 7 has extended the RTSP 1.0 to support the Fast Content Switching and to shorten start-up period (3GPP TS 26.234 R7, “Transparent end-to-end Packet-switched Streaming Service (PSS); Protocols and codecs”, available from http://www.3gpp.org). Such an extension is built on top of PSS services, which enables fast content switch not only on live contents, but also on video on-demand contents. It reduces client/server interactions to a minimum, which allows faster start up and switching of contents. Additionally, clients are enabled to reuse the existing RTSP control session and Real-time Transport Protocol (RTP) resources while switching to new content.

In most cases, a content switch can be initiated with a single RTSP request. In order to preserve interoperability with RTSP aware intermediate devices such as application layer gateways, terminals should ensure that SETUP requests and responses are sent for each RTP/RTCP port pair to be used. Once a port pair has been negotiated, it may be reused for subsequent content upon a switch.

The “Switch-Stream” header field may be used in an RTSP PLAY request or an RTSP PLAY response message. It is used to describe the replacement of media streams after a content switch. The “Switch-Stream” header field may be used with aggregated control and with media control URLs.

If both old media stream and new media stream URLs are indicated in the “Switch-Stream” header field of a PLAY request from a terminal to a media server, then the media server shall interpret this as a request to replace the old media stream with the new media stream, hence reusing the transport parameters of the old media stream for the new media stream.

If the “Switch-Stream” header field is included in a PLAY response from a media server to a terminal, then this header informs the client about the media streams that are currently being streamed to the terminal. The old media stream may be omitted in this case.

If only the new media stream URL is indicated in the “Switch-Stream” header field of a PLAY request from a terminal to a media server, then the media server shall interpret this as a request to switch to the new media stream, replacing any of the terminated media streams. In that case, the media server shall indicate the synchronization source (SSRC) of the new media stream in the RTP-Info of the reply, in order to enable the terminal to locate the new stream.

If only the old stream URL is indicated in the “Switch-Stream” header field of a PLAY request from a terminal to a media server, then the media server shall interpret this as a request for complete removal of the specified media stream. The terminal and the media server release the resources for this stream without explicit TEARDOWN signalling.

In 3GPP TS 26.234 R7, the following scenarios relating to content switch are described:

1) Content Switch with SDP (Session Description Protocol)

FIG. 1 is a schematic signal diagram illustrating a conventional procedure of fast content switching with an available SDP. SDP, which was published by IETF as RFC 2327, is used to describe and negotiate streaming media initialization parameters. In this scenario, the terminal has retrieved the SDP prior to the content switch and has probed the server features during an earlier interaction. This PSS feature reduces the switching to new content to a single client-server interaction. The feature-tag indicating this feature is “3gpp-switch”, as shown in FIG. 1. The terminal shall use the “Require” header with this feature tag value, when requesting this behaviour from the server. The server shall use the PLAY method with the “3gpp-switch” feature tag in the “Require” header when the terminal requests this feature. Thus, the server replaces the current RTSP PLAY request by the new request resulting in a switch of streamed content. The server includes always the “Switch-Stream” header in the response.

2) Stream-Level Switching

FIG. 2 is a schematic signal diagram illustrating a conventional procedure of stream-level switching. The term “content” mentioned in the above scenario can be deemed as an aggregation of at least one media streams such as audio and video streams. However, the switching can be performed on a level of stream.

Some content may be available for streaming in different representations. An example of such a use case is the live streaming of a sport event with multiple camera views. The SDP available at the terminal describes multiple options for one or several media types (e.g. video, audio, or subtitles). Upon initial setup of the session, the user selects the preferred combination of the presentation to be consumed and sets up the corresponding media streams. At a later point, the user may trigger a switch to a different media stream carrying an alternative representation of the media.

The feature tag “3gpp-switch-stream” is defined to describe support for this feature, as shown in FIG. 2. The terminal should use the “Require” header with this feature tag value when requesting this behaviour from the server.

3) Stream Adding

FIG. 3 is a schematic signal diagram illustrating a conventional procedure of stream adding.

As shown in FIG. 3, a terminal wishing to add the streaming of a specific media stream shall send SETUP request to negotiate transportation ports. After receiving a successful response from the media server, the PSS terminal shall send PLAY request to ask the media server to deliver media data of the new added stream.

The PLAY request includes a “Switch-Stream” header indicating the URL of the media stream to be added as the new media stream. No URL for the old media stream should be specified. Upon receiving the PLAY request with “Switch-Stream” header field indicating that one or more media streams are to be added, the media server shall interpret this as a request to switch to the new media stream, replacing any of the terminated media streams, and it shall indicate the SSRC of the new media streams in the RTP-Info of the reply, in order to enable the PSS client to locate the new stream.

4) Stream Removing

FIG. 4 is a schematic signal diagram illustrating a conventional procedure of stream removing.

A terminal wishing to terminate the streaming of a specific media stream shall send a PLAY request with a “Switch-Stream” header indicating the URL of the media stream to be torn down as the old media stream. No URL for the new media stream should be specified. Upon receiving a PLAY request with “Switch-Stream” header field indicating that one or more media streams are to be terminated, the server shall stop streaming the indicated media streams and release the used UDP ports for this media component and free the associated resources.

In the previously known techniques, all the switching operations are initiated by the client. The terminal initiates the RTSP request to tell the media server that he wants to take some action, for example, to play media data on a service channel.

However, in some situations the operator would like to insert a clip such as a commercial advertisement, emergency announcement or program list, no matter before, in the middle of, or at the end of the service channel, in the middle of the service channel or at the end of the service channel. However, the 3GPP standard and prior art only describe switching initiated by the terminal. Thereby the operator is not able to get profits from advertisement business, for example when they can not initiate the switching procedure.

### SUMMARY

Therefore, it is an object of the present invention to address the problem outlined above by providing a method and apparatus for initiating content switching by a media server.

According to one aspect of the present invention, there is provided a method for a media server initiating fast content switching in a communication network, said method comprising the steps of: sending a first message to a terminal which is receiving or requesting a first content data, informing the terminal a switching to a second content data; and delivering the second content data to the terminal.

In one embodiment of the present invention, the method may further comprise the step of upon finishing delivering the second content data, sending a second message to the terminal to switch back to the first content data.

Preferably, the first message is a Real Time Streaming Protocol ANNOUNCE request message including a Server-Switch Header with value “Server-switch: 1” indicating a switching to a second content data and a Switch-Stream header with related switching information. The Real Time Streaming Protocol ANNOUNCE request message may comprises Real-time Transport Protocol-specific parameters of the second content data in RTP-Info header.

Preferably, the first message is a Real Time Streaming Protocol PLAY response message with Real-time Transport Protocol-specific parameters of the second content data contained in RTP-Info header. The second message may be a Real Time Streaming Protocol ANNOUNCE request message including a Server-Switch Header with value “Server-switch: 1” indicating a switching to the first content data and a Switch-Stream header with related switching information.

In one embodiment of the present invention, the first message may include a SDP-Informed Header with value “sdp-informed: 1” which indicates the codec or resolution of the second content data is different from that of the first content data, so that SDP information related to the second content data need to be included.

The method may further comprise the steps of: establishing a Real Time Streaming Protocol session and requesting the second content data from a Content Provider/Service Provider server before the step of sending the first message; and tearing down the Real Time Streaming Protocol session with the CP/SP server after finishing delivering the second content data.

The first content data and the second content data each may comprise at least one media streams such as video stream, audio stream and text stream.

In one embodiment of the present invention, the switching is performed on level of media stream, comprising switching to a new media stream, adding a media stream and removing of a current media steam. In this case, the first message may further include a “Require” header with value “3gpp-switch-stream” indicating the switching of media stream level. The “Switch-Stream” header may include at least one of the Uniform Resource Locators of the media streams of the first content and the second content.

According to another aspect of the present invention, there is provided a media server for initiating fast content switching in a communication network. The media server may comprises a switching manager arranged for generating a first message and sending it to a terminal which is receiving or requesting a first content data informing the terminal a switching to a second content data, and a media manager arranged for delivering the second content data to the terminal.

According to further aspect of the present invention, there is provided a method for a terminal switching content in a communication network. The method may comprise the step of receiving a first message from a media server, the first message informing the terminal a switching from a first content data to a second content data. The method may further comprise the step of receiving and rendering the second content data from the media server.

According to further aspect of the present invention, there is provided a terminal which is capable of switching content in a communication network. The terminal may comprise a signal manager arranged for receiving a first message from a media server, the first message informing the terminal a switching from a first content data to a second content data. The terminal may further comprise a media manager arranged for receiving and rendering the to second content data from the media server.

According to further aspect of the present invention, there is provided a communication system, which comprising a media server for initiating fast content switching and a client.

### BRIEF DESCRIPTION OF THE DRAWINGS

The invention, together with further objects and advantages thereof, will be best understood by reference to the following description taken together with the accompanying drawings, in which:

FIG. 1 is a schematic signal diagram illustrating a conventional procedure of fast content switching with an available SDP;

FIG. 2 is a schematic signal diagram illustrating a conventional procedure of stream-level switching;

FIG. 3 is a schematic signal diagram illustrating a conventional procedure of stream adding;

FIG. 4 is a schematic signal diagram illustrating a conventional procedure of stream removing;

FIG. 5 is a system overview according to an embodiment of the invention;

FIG. 6 is a schematic signal diagram illustrating a procedure of content switching initiated by a media server according to an embodiment of the invention;

FIGS. 7A and 7B are schematic signal diagrams illustrating a procedure of switching to new content with same codec and resolution initiated by a media server according to an embodiment of the invention;

FIGS. 8A and 8B are schematic signal diagrams illustrating a procedure of switching to new content with different codec or resolution initiated by a media server according to an embodiment of the invention;

FIG. 9 is a schematic signal diagram illustrating a procedure of stream-level switching initiated by a media server according to an embodiment of the invention;

FIGS. 10A and 10B are schematic signal diagrams illustrating a procedure of stream adding initiated by a media server according to an embodiment of the invention;

FIG. 11 is a schematic signal diagram illustrating a procedure of stream removing initiated by a media server according to an embodiment of the invention; and

FIGS. 12A and 12B are schematic block diagrams of the media server and the terminal according to an embodiment of the present invention

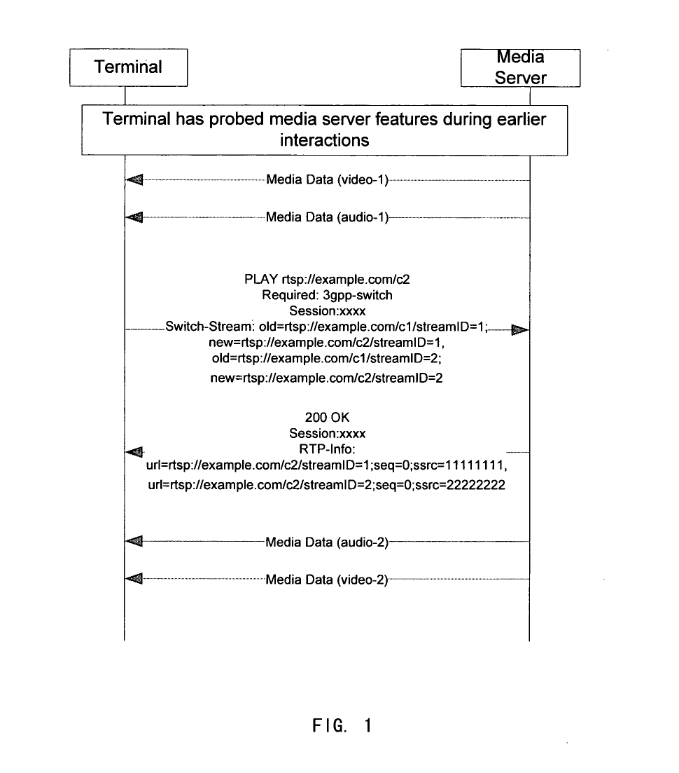

### DETAILED DESCRIPTION

Throughout the drawings, the same reference characters will be used for corresponding or similar elements.

Before describing various embodiments in detail, it is to be understood that this invention is not limited to the particular component parts of the devices described or process steps of the methods described as such devices and methods may vary. It is also to be understood that the terminology used herein is for purposes of describing particular embodiments only, and is not intended to be limiting. It must be noted that, as used in the specification and the appended claims, the singular forms “a”, “an” and “the” may also encompass plural referents unless the context clearly dictates otherwise. Thus, for example, the term “a terminal” may refer to one or more terminals, and the like.

Briefly described, a method and an arrangement are provided for supporting content switching initiated by a media server. The term “terminal” used herein may mean a mobile terminal, e.g. a mobile or cellular phone or a mobile TV client, but it may also mean some other type of terminal possible to connect to a communication network and play streaming media data. The term media server used herein may mean a server which stores or have access to media data and is able to provide it to terminals using streaming.

Although the embodiments of the present invention is illustrated in context of a 3GPP PSS mobile TV system, the teaching of the present invention can also be applied to other communication systems, such as broadcast-based or unicast-based IPTV, Video On Demand (VOD) or video conference systems. In the embodiments the content or media data is shown as advertisement clips with video and audio streams, however, it should not be limited to this. It can be any media of any form that can be delivered by the media server and rendered at the terminal, including, but being not limited to, an emergency announcement or living concert in the form of image, video, audio, subtitle, etc. In the figures, the media session is performed as an RTSP session and therefore the terminology of such RTSP requests and responses have been employed in the figures and corresponding, description. The teaching of the present invention could also be applied to other protocols used for setting up and managing a media session.

For a better understanding of the invention it may be useful to begin with a brief system overview.

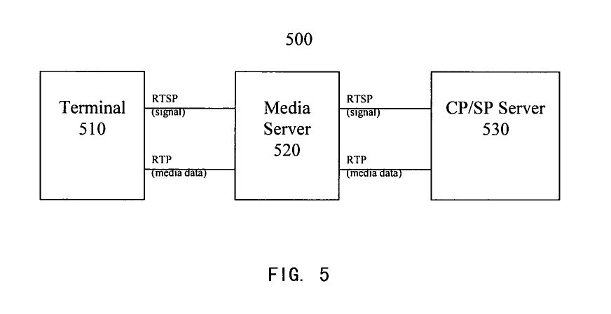

With reference to FIG. 5, a representative system overview according to an embodiment of the invention will be described. As shown in FIG. 5, a streaming system such as a 3GPP PSS communication system 500 includes a terminal 510, a media server 520 and a Content Provider (CP)/Service Provider (SP) server 530.

In the typical PSS Client/Server model, the terminal 510 is capable of streaming and rendering media, while the media server 520 is capable of delivering streaming services towards the terminal 510. In signalling plane, the terminal 510 communicates with the media server 520 via RTSP. And in data plane, the media server 520 delivers media data towards the terminal 510 via RTP.

In a normal deployment, the media server 520 may be owned and managed by the operator. Although the media server 520 may provide streaming services to the terminal 510, currently most of contents such as movies or advertisements are owned by the content/service provider. The CP/SP server 530, which is owned by the content provider or service provider, may also offer streaming service of their own contents via the operator. The interfaces between the media server 520 and the CP/SP server 530 may be of any type. In one typical implementation, the communication between the media server 520 and the CP/SP server 530 is still performed using RTSP for signalling and RTP for media data. It should be noted that, the CP/SP server 530 and the media server 520 may be situated at different locations, or at the same location. It is also possible that the media server 520 stores the content of the CP/SP server 530, and in this case, the CP/SP server 530 may not be a necessary element, or may be deemed as being physically or functionally incorporated into the media server 520.

In order to make profits from advertisement, the operator needs a mechanism which supports content switch initiated by the media server. Besides, such a mechanism can also provide more flexibility for the operator, for example, to deliver valuable or important information such as an emergency announcement or news to users.

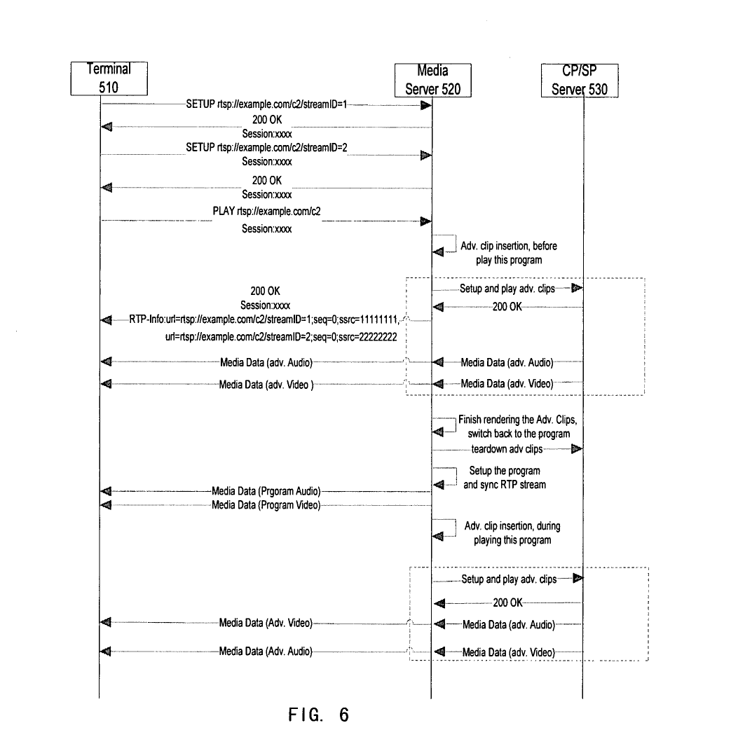

FIG. 6 is a schematic signal diagram illustrating a procedure of content switching initiated by a media server 520 according to an embodiment of the invention. Firstly, according to the requests for both video and audio of media content (e.g. a program) by the terminal 510, the RTSP session between the terminal 510 and the media server 520 is established. The media server 520 decides to insert, for example, an advertisement clip before rendering the program. The media server 520 establishes a RTSP session relating to the advertisement clip towards the CP/SP server 530, receives the media data of the advertisement clip, and forwards it to the terminal. After finishing delivering the advertisement clip, the media server 520 teardowns the RTSP session relating to the advertisement clip, and delivers the program media steams towards the terminal 510 afterwards.

In this approach, the media server may initiate content switching on its own, and insert media such as an advertisement clip at any time, for example, before, during and at the end of the program playing.

However, in the above solution, without further signals from the media server to the terminal to inform the content switching operation, the media server has to perform a synchronization operation between the streams of the advertisement clip and the ones of the program, so that the user of the terminal will not be aware of the switching operation.

In this approach, the media server has to synchronize the RTP packets between the contents for the program and the advertisement clip, since the media server has to reuse the RTP streaming session. In another word, the terminal should be unaware of the differences between the contents for the program and the advertisement clip. From the terminal's perspective, it requires both the program and advertisement clip are delivered as the same streams. As the streams are continuous, the terminal would expect the codec and resolution are kept unchanged. Otherwise, the terminal may encounter some errors. Thus, all the contents including the program and advertisement clip have to be encoded in the same codec and resolution.

The invention proposes a solution that allows the media server to initiate content switching by utilizing the ANNOUNCE method without the need of the above synchronization operation.

According to RFC 2326 Real Time Streaming Protocol, the ANNOUNCE method could be sent from the terminal to the media server and from the media server to the terminal. This method serves two purposes: When sent from the terminal to the media server, ANNOUNCE posts the description of a presentation or media object identified by the request URL to the media server. When sent from the media server to the terminal, ANNOUNCE updates the session description in real-time.

In this way, when the content switch takes place in the media server side, the media server could use the ANNOUNCE method to notify the terminal to make the terminal to be aware of that. Also, the RTP-Info header could be reused to inform the terminal about the new RTP-specific parameters. When the terminal receives the ANNOUNCE with the RTP-Info field, it should check the terminal buffer to pick up the new RTP streams, then start a new decoder or update the current decoder to render the new RTP streams.

Besides reusing existing RTSP elements, the present invention conceives two new RTSP headers for ANNOUNCE method could be introduced to facilitate content switching operation initiated by the media server:

Server-Switch-Request-Header=“server-switch: 1”

SDP-Informed-Header=“sdp-informed: 1”

If the terminal receive the RTSP ANNOUNCE request with the “Server-Switch” header indicating “server-switch: 1”, it means that media server has initiated content switching for some reasons, the terminal should retrieve the RTP related information from RTP-Info header and decode the RTP packets according to new SSRC, sequence number and timestamp.

If the RTSP ANNOUNCE request includes the “SDP-Informed” Header indicating “sdp-informed: 1”, it means that the media server will send the new streams with different codec or resolution compared with the previous ones. The codec related information could be fetched from SDP which is included in the message body of the RTSP ANNOUNCE request.

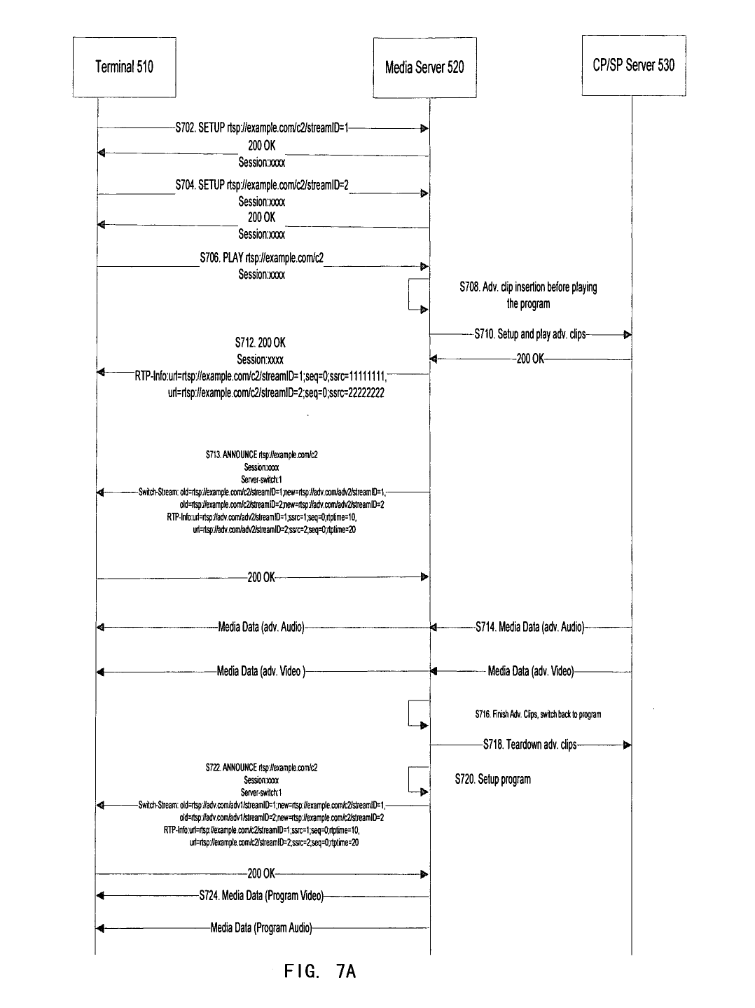

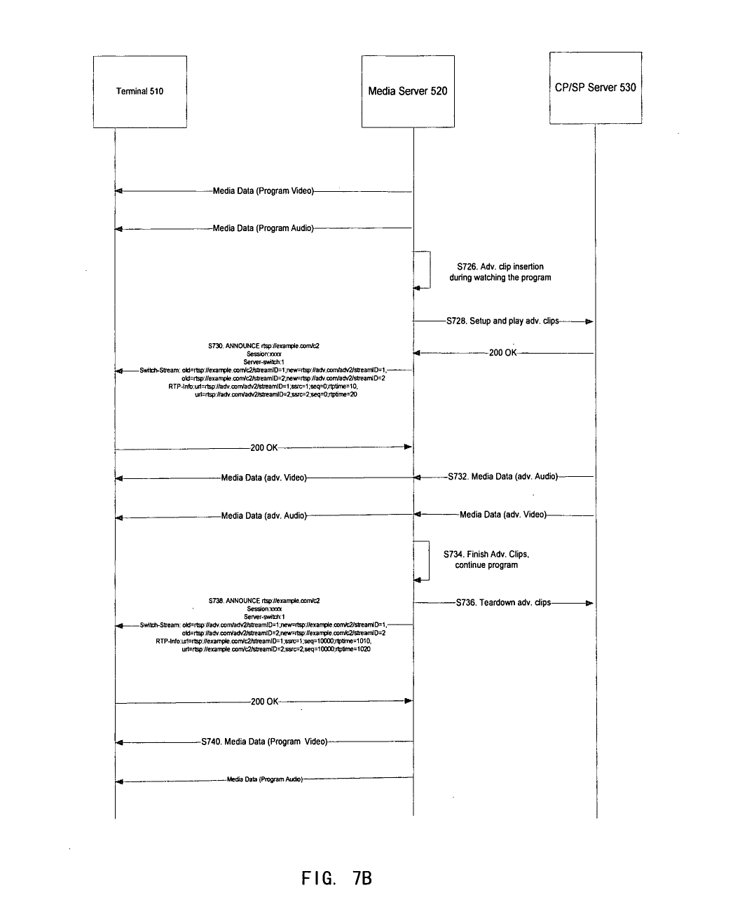

The embodiments of the present invention will be described with reference to FIGS. 7-10.

Switching to New Content with Same Codec

FIGS. 7A and 7B are schematic signal diagrams illustrating a procedure of switching to new content with same codec initiated by a media server according to an embodiment of the invention.

Assume that the codec and resolution of the new content are kept unchanged. When the media server wants to change the content of the RTSP session, for example insert into one advertisement clip, the media server sends an ANNOUNCE request with the RTP-Info to the terminal. The “RTP-Info” header includes a synchronization source (SSRC), RTP timestamp and sequence number parameters.

When the terminal receives the ANNOUNCE request with the RTP-info, it will know how to decode the new streaming according to the RTP-Info together with the old SDP information.

Now referring to FIG. 7A, first we will consider the case of inserting an advertisement clip before playing the program which corresponds to steps S702-S724. In the description hereafter, the program data that the user wants to watch is referred to as program media data and is shown as including program video and program audio. The advertisement clip data is referred to as advertisement media data, and is shown as including advertisement video and advertisement audio.

In step S702, the terminal 510 sends a RTSP SETUP request towards the media server 520 to negotiate transportation parameters for one stream which for example corresponds to the program video, and the media server 520 responds 200 OK. In step S704, the terminal 510 sends another RTSP SETUP request towards the media server 520 to negotiate transportation parameters for another stream which for example corresponds to the program audio, and the media server 520 responds 200 OK. The terminal 510 then sends a RTSP PLAY request towards the media server 520 requesting the program media data in step S706. In step S708, according to the predetermined policy of the operator, for example, the media server 520 decides to insert the advertisement media data before rendering the program media data towards the client. In step S710, the media server 520 establishes a RTSP session and requests the advertisement media data from the CP/SP server 530, and the CP/SP server 530 responds 200 OK. In step S712, the media server 520 sends a RTSP PLAY response (200 OK) towards the terminal 510. In step S713, the media server 520 sends an ANNOUNCE request to the terminal 510 to inform that a switch operation is to be performed on the media server side by including therein a “Server-Switch” Header indicating “server-switch: 1”. As shown in FIG. 7, the ANNOUNCE request also includes a “Switch-Stream” header with switching information. To have enough RTP information on the new streams, the ANNOUNCE request includes RTP-Info which may at least contains the SSRC, sequence number and RTP timestamp information of the new streams of the advertisement media data. The terminal 510 receives the ANNOUNCE request and knows that the media server 520 is going to switch from the program media data to the advertisement media data. The advertisement media data including video and audio are then sent from CP/SP server 530 towards the terminal 510 via the media server 520 in step S714. Thereby, the terminal 510 begins to receive and render the advertisement media data from the media server 520.

After finish the delivering of advertisement clip, the media server 520 decides to switch back to render program media data towards the terminal 510 in step S716. In step S718, the media server 520 tears down the RTSP session of the advertisement media data with the CP/SP server 530. In step S720, the media server 520 setups the program media data for the terminal 510. The media server 520 sends another ANNOUNCE request to the terminal 510 to inform that another switch operation is to be performed on the media server side in step S722. The format of the ANNOUNCE request is the same as that of the previous ANNOUNCE request. The terminal 510 receives the ANNOUNCE request, knows that the media server 520 is going to switch from the advertisement media data back to the program media data, and responds 200 OK to accept such change. In step S724, the media server 520 sends program media data towards the terminal 510 without any needs to synchronize the RTP streams. Thereby, the terminal 510 begins to receive and render the program media data from the media server 520.

As an alternative embodiment, the steps S712 and S713 can be combined into one step. In this embodiment, the media server 520 sends a RTSP PLAY response (200 OK) with RTP-specific parameters of the advertisement media data contained in RTP-Info header towards the terminal 510, informing the terminal 510 that a switch operation is to be performed on the media server side. The step S713 of sending ANNOUNCE request together with the corresponding 200 OK response may be omitted, which simplifies the signal flow of the procedure and improves the efficiency.

Next, the case of inserting an advertisement clip during playing the program will be described with reference to FIG. 7B.

In step S726, while the user is watching the program, the media server 520 decides to insert advertisement media data according to the policy of the operator. For example, the operator may want to insert advertisement regularly during a TV program, or insert advertisement during a timeout of a living sport event.

In step S728, the media server 520 establishes a RTSP session and requests the advertisement media data from the CP/SP server 530, and the CP/SP server 530 responds 200 OK

The media server 520 sends another ANNOUNCE request to the terminal 510 to inform that a switch operation is performed on the media server side by including therein a “Server-Switch” Header indicating “server-switch: 1” in step S730. “Switch-Stream” and “RTP-Info” headers should also be included in the ANNOUNCE request, which is similar to that of step S713. The terminal 510 receives the ANNOUNCE request, knows that the media server 520 is going to switch from the program media data to the advertisement media data, and responds 200 OK to accept such change.

The advertisement media data including video and audio are then sent from the CP/SP server 530 towards the terminal 510 via the media server 520 in step S732. Thereby, the terminal 510 begins to receive and render the advertisement media data from the media server 520.

After finish the delivering of advertisement clip, the media server 520 will switch back to render the program media data towards the terminal 510 in steps S734-S740, which are similar to steps S716-S724.

The case of inserting an advertisement clip at the end of the program is almost the same as that during playing the program, except that the server 520 does not need to switch back to the program media data after finish the delivering of the advertisement. Thus the detailed description thereof will be omitted.

The above description is made on the assumption that the new content is the same as the old one from codec and resolution point of view, so that the terminal 510 could reuse the SDP information of the old content. However, that might not always be the case.

Switching to New Content with Different Codec

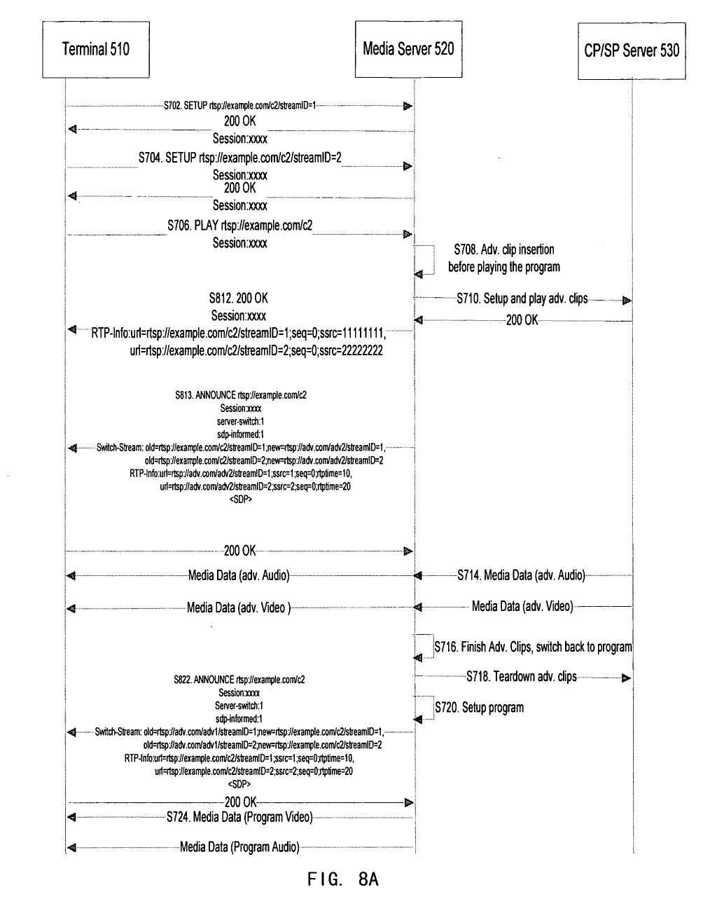

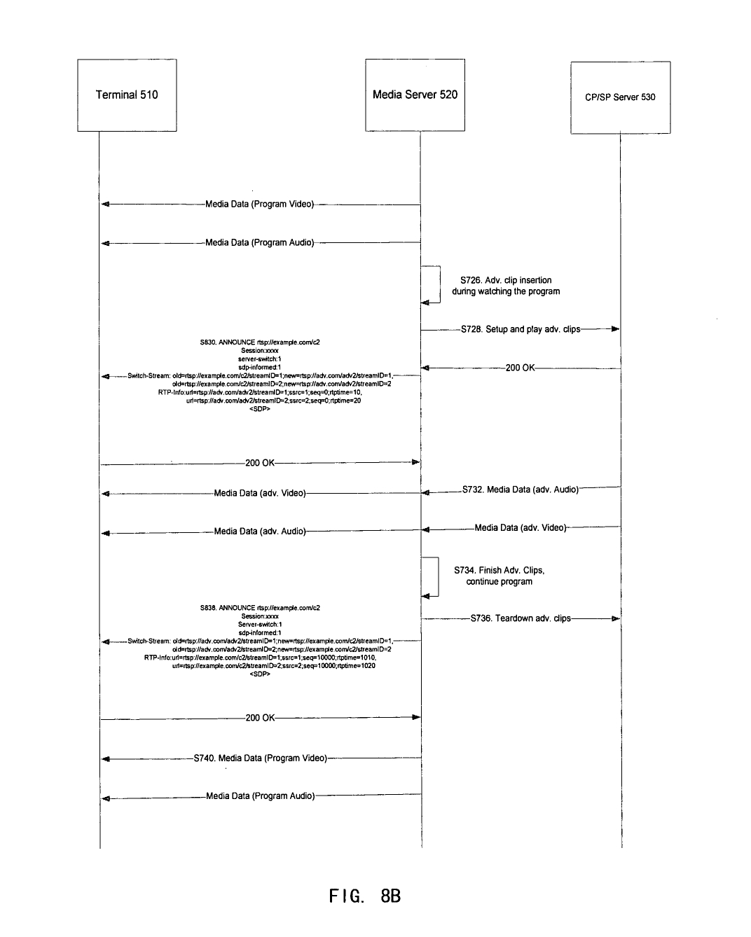

FIGS. 8A and 8B are schematic signal diagrams illustrating a procedure of switching to new content with different codec or resolution initiated by a media server according to an embodiment of the invention.

If the media server 520 finds the codec of the new content (e.g. advertisement media data) is different from the program the terminal 510 is currently receiving, it should inform the terminal 510 the new SDP information. In order to signal that the SDP is changed, the media server 520 will include in an ANNOUNCE request SDP-informed header indicating “sdp-informed: 1”.

When the terminal 510 receives the ANNOUNCE request with the RTP-Info and “SDP-informed” header as well as the SDP information relating to the advertisement media data, it does know the streaming from the media server 520 will change the codec. Then the terminal 510 will parse the SDP information and create a new decoder or update the decoder with the new SDP to decode the new streams.

The procedure of FIGS. 8A and 8B is almost the same as that of FIGS. 7A and 7B, except for step S813, S822, S830 and S838. The media server 520 needs to inform the terminal 510 of the SDP information relating to the advertisement media data which are encoded in different codec and resolution. In steps S813, S822, S830 and S838, in the RTSP ANNOUNCE request, the media server 520 includes the SDP information in RTSP message body along with “SDP-informed” header indicating “sdp-informed: 1”.

As an alternative embodiment, the steps S812 and S813 can be combined into one step. In this embodiment, the media server 520 sends a response to the PLAY request (200 OK) with RTP-specific parameters of the advertisement media data contained in RTP-Info header as well as the SDP information and SDP-informed header indicating “sdp-informed: 1”, informing the terminal 510 that a switch operation to new content with different codec and resolution is to be performed on the media server side. The step S813 of sending ANNOUNCE request together with the corresponding 200 OK response may be omitted, which simplifies the signal flow of the procedure and improves the efficiency.

Although in the present invention the contents are shown as with different codec, it is apparent to those skilled in the art that the SDP information is not limited to codec and may comprise other parameters such as resolution. Thus the invention may be applied to the case of switching to new content with other different SDP information as well.

Stream-Level Switching

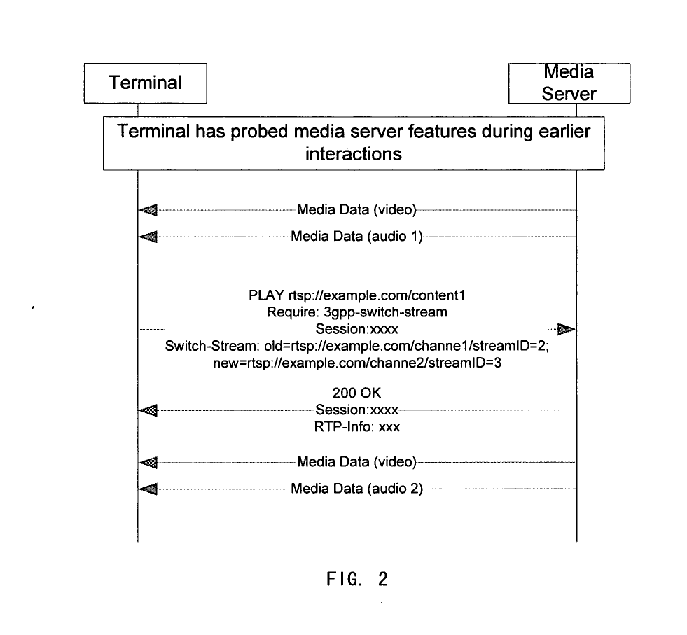

As have been described above in the scenario 2) with reference to FIG. 2, the terminal may trigger a switch to a different media stream by introducing the “Require” header with the feature tag “3gpp-switch-stream” in a PLAY request. The stream-level switching can be deemed as a special case of content switching. Consider the case where a sport event is available for streaming in different representations. For example, multiple camera views (video) and commentator languages (audio or subtitle) are available for the user selection. The user may switch camera views and commentator languages as he/she wishes, however, since the terminal is typically compact and not user-friendly, the user may find it inconvenient to trigger a switch to a different media stream during watching the sport event by himself/herself.

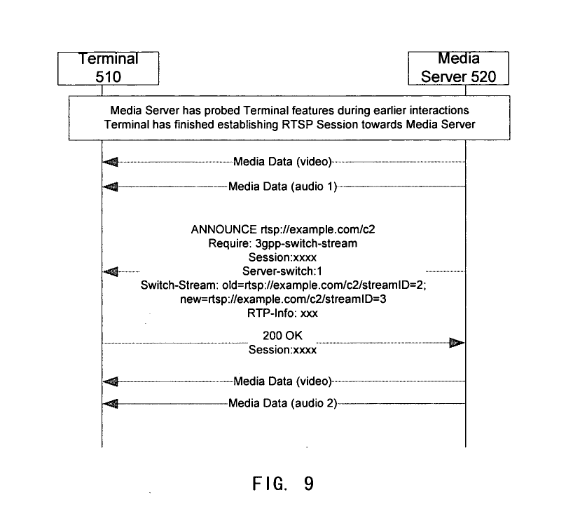

The invention proposes a stream-level switching initiated by the media server by utilizing the ANNOUNCE method. With reference to FIG. 9, a procedure of stream-level switching operation initiated by a media server according to an embodiment of the invention will be described. The CP/SP server 530 is not an indispensable element if the new stream is owned by the media server 520. For clarity and simplicity, the CP/SP server 530 is not shown in FIG. 9.

During playing, the media server 520 sends an ANNOUNCE request towards the terminal 510. In addition to the “3gpp-switch-stream”, the ANNOUNCE request includes a “Server-Switch” header indicating “server-switch: 1”, informing the stream-level switch operation initiated by the media server 520. As shown in “Switch-Stream” header of the ANNOUNCE request in FIG. 9, only the audio stream whose URL is indicated by “old” is replaced with another audio stream whose URL is indicated by “new”. The video stream is kept unchanged. The terminal 510 receives the ANNOUCE request from the media server 520 and responds with 200 OK. Then the terminal 510 begins to receive and render the original video stream and the new-switched audio stream.

The media server 520 may determine when and how to switch stream according to, for example, a most popular combination of representations or a specific user's preference, in order to improve the user experience. The stream switching may be audio switching, such as switching from English language track to Chinese language track, from TV program audio to advertisement or emergency announcement with only audio; or video switching, such as switching between different video encoders with different angle of views (e.g. several encoders for a live show); or text switching, such as switching from subtitles of a program to subtitles of an advertisement, etc.

The stream-level switching initiated by the media server may also be advantageous in many other situations. For example, the media server may decide to switch to a higher bandwidth or lower bandwidth stream for a same content, due to detecting some bandwidth changes in real time, in order to reserve bandwidth or improve user experience.

Since the stream-level can be deemed as a specific case of content switching, it is apparent for those skilled in the art to apply it to other cases such as switching to stream(s) with/without SDP or with same or different codec, based on the teaching given above.

Stream Adding

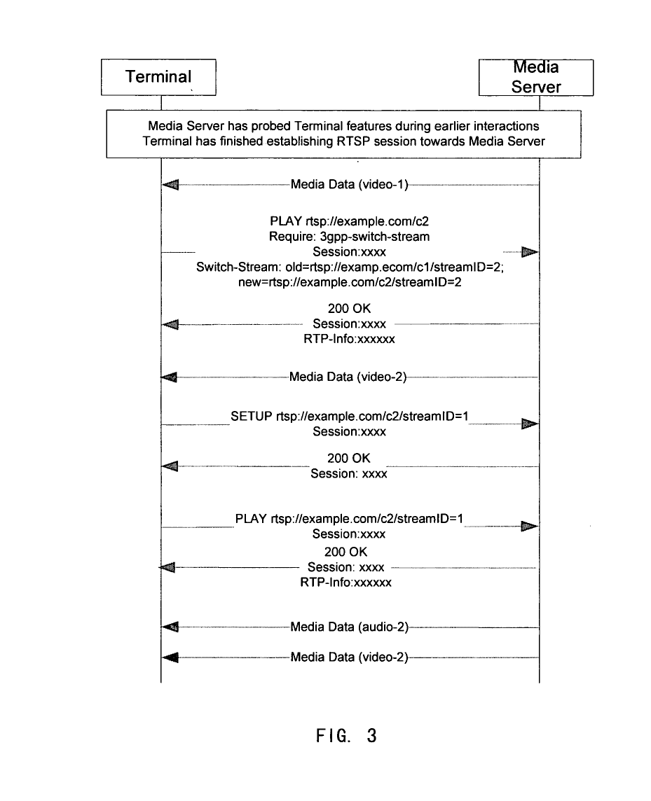

As have been described above in the scenario 3) with reference to FIG. 3, the terminal needs to send a SETUP request to negotiate transportation ports and then send a PLAY request to trigger media data delivery.

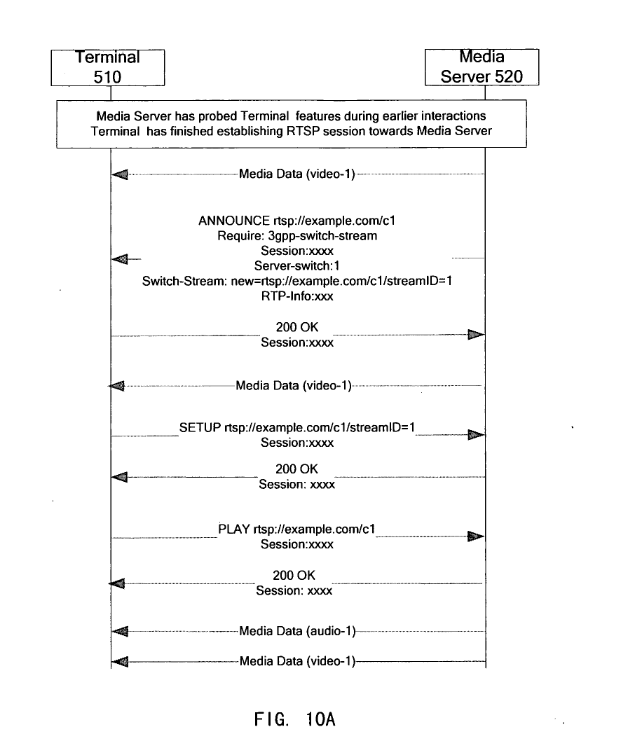

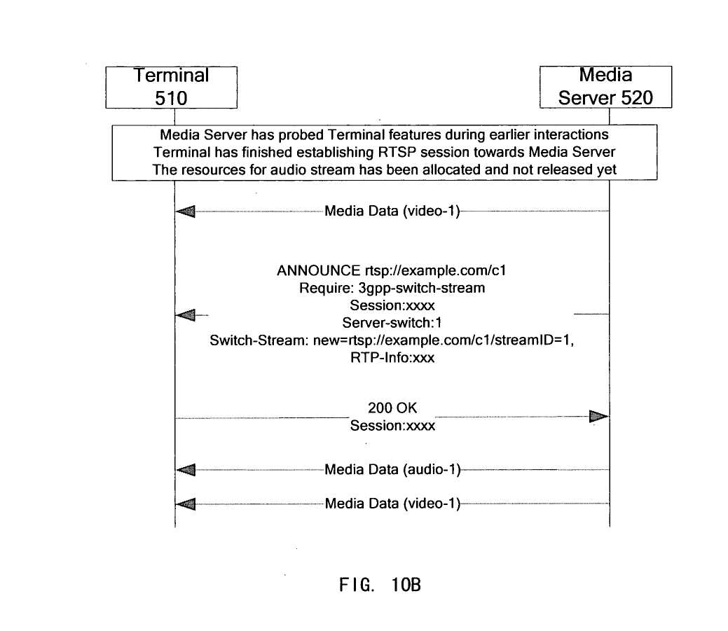

The invention proposes a stream adding operation initiated by the streaming server by utilizing the ANNOUNCE method. With reference to FIG. 10A, a procedure of stream adding operation initiated by the media server 520 according to an embodiment of the invention will be described.

As shown in FIG. 10A, the media server 520 sends ANNOUNCE request towards the terminal 510. In addition to the “3gpp-switch-stream”, the ANNOUNCE request includes a “Server-Switch: 1” in RTSP headers, indicating the switch operation initiated by the streaming server 520. As shown in “Switch-Stream” header in FIG. 10A, a new media stream without corresponding old media stream indicates that the media server 520 is going to add a media stream. The terminal 510 sends a SETUP request to establish the transportation resources for the new stream(s) firstly. After the successful establishment of the new media stream(s), the terminal 510 sends a PLAY request to ask the media server to deliver media data of new streams.

As an exception, if one or more streams to be added were once removed due to some reasons, and the related resources are not released yet, it is not necessary to use the SETUP request/response to negotiate transportation ports. That is, the ports on the terminal 510 and media server 520 have already been allocated and the network resources have also been allocated (Usually, the ports on firewall were opened). In this case, there is no need to have a new SETUP request/response, and the resources for the old SETUP request/response could be reused directly.

Now with reference to FIG. 10B, a procedure of stream adding operation initiated by the media server 520 according to another embodiment of the invention will be described. As shown in FIG. 10B, assume the resources for the audio stream has been allocated and not released yet, those resources could be reused directly, and it is not necessary to use the SETUP request/response to negotiate transportation ports and the following PLAY request/response to trigger the delivery of the new streams. So, the SETUP and PLAY request/response may be omitted

Stream Removal

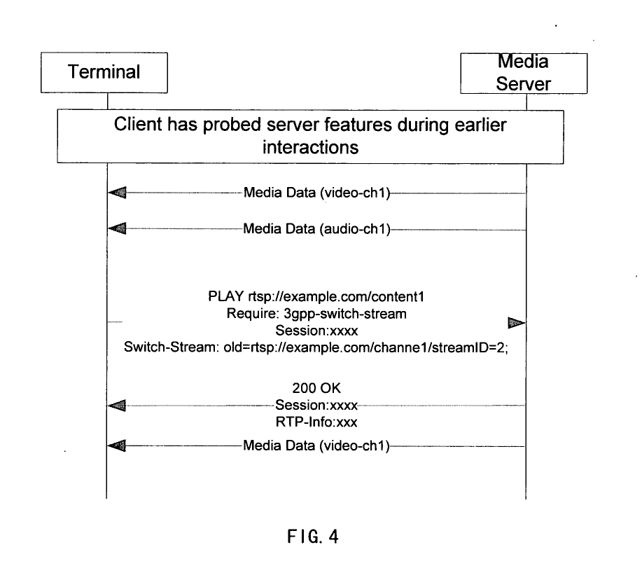

As have been described above in the scenario 4) with reference to FIG. 4, the terminal may terminate the streaming of a specific media stream by sending a PLAY request with a “Switch-Stream” header indicating the URL of the media stream to be torn down as the old media stream while introducing the feature tag “3 gpp-switch-stream”.

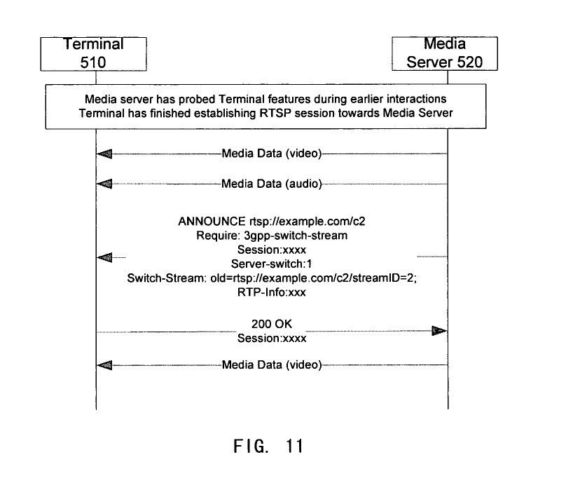

The invention proposes a stream removal initiated by the media server by utilizing the ANNOUNCE method. With reference to FIG. 11, a procedure of stream removal operation initiated by a media server according to an embodiment of the invention will be described.

During playing, the media server 520 sends an ANNOUNCE request towards the terminal 510. In addition to the “3gpp-switch-stream”, the ANNOUNCE request includes a “Server-Switch” header indicating “server-switch: 1”, informing the switch operation initiated by the media server. As shown in “Switch-Stream” header of the ANNOUNCE request in FIG. 11, only one old stream (audio) is indicated, which would be interpreted as a stream removal request. Thus the audio stream is removed and the video stream is kept unchanged. The terminal 510 receives the ANNOUCE request from the media server 520 and responds with 200 OK. Then the terminal 510 begins to receive and render only the original video stream.

The ability to initiate a stream removal brings the media server more flexibility. For example, the media server may remove one of the video stream and audio stream to save bandwidth, or may temporarily bleep the audio or block the video due to some reasons.

The fast content (stream) switching procedure of the invention does not necessarily have to follow the signaling described in connection with FIGS. 6-11. Instead, the signaling may be combined in any suitable order.

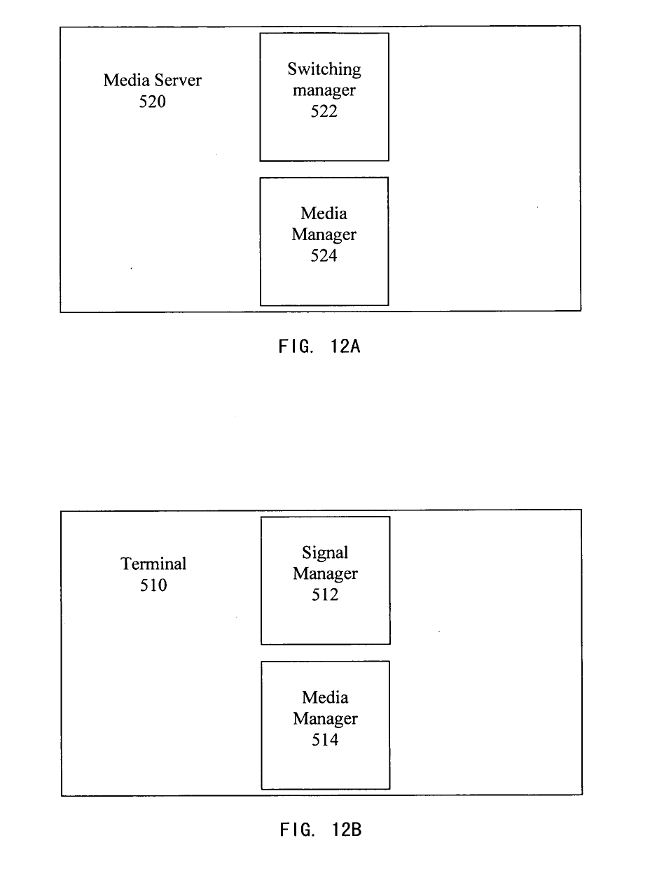

FIG. 12A is a schematic block diagram of the media server 520 according to an embodiment of the present invention. Besides the conventional functionality such as modulator/demodulator, encoder/decoder, etc., the media server 520 comprises a switching manager 522 that functions as a means for performing the foregoing content or stream switching procedure with the terminal 510. The switching manager 522 generates at least one of the ANNOUNCE request message and PLAY response message as defined by the invention and sends it to the terminal 510, to inform the terminal 510 of a switching initiated by the media server 520. The switching manager 522 also processes the response message corresponding to the ANNOUNCE request message from the terminal 510. Preferably, the switching manager 522 may include or externally connect to a controller (not shown) which for example decides the policy to initiate the switching. The switching manager 522 may also handle all other RTSP messages from the terminal 510.

The media server 520 further comprises a media manager 524, which takes care of the media processing, such as setting up or tearing down RTSP sessions with the CP/SP server 530, receiving media data from the CP/SP server 530 and delivering media data to the terminal 510.

FIG. 12B is a schematic block diagram of the terminal 510 according to an embodiment of the present invention. Besides the conventional functionality such as modulator/demodulator, encoder/decoder, etc., the terminal 510 comprises a signal manager 512, which receives at least one of the ANNOUNCE request message and PLAY response message as defined by the invention from the media server 520. The signal manager 512 may also handle all other RTSP messages. The terminal 510 further comprises a media manager 514, which takes care of the media processing, including receiving RTP data and rendering media data from the media server 520, etc.

With the fast content (steam) switching initiated by the streaming server, the present invention is able to provide a flexible solution for the operator to insert content such as advertisement, add, switch or remove media streams, so that the operator can gain business profits or improve the user experience, etc. The solution of the present invention adapts the existing ANNOUNCE request to initiate the switching, and does not need complicated alteration in hardware and software of the current terminals or server. It allows smooth and seamless switching between contents or streams with same or different codec without the need of synchronization operation between the streams.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from its central scope. Therefore it is intended that the present invention not be limited to the particular embodiment disclosed as the best mode contemplated for carrying out the present invention, but that the present invention include all embodiments falling within the scope of the appended claims.

1-26. (canceled)

27. A method implemented by a media server for initiating fast content switching in a communication network, said method comprising:
sending a first message to a terminal that is receiving or requesting first content data, the first message informing the terminal about a switch initiated by the media server to second content data; and
delivering said second content data to the terminal.

28. The method according to claim 27, wherein the first message comprises an Real Time Streaming Protocol (RTSP) request message or an RTSP response message.

29. The method according to claim 28, wherein the first message comprises an RTSP ANNOUNCE request message that includes a Server-Switch header with a value indicating said switch to said second content data and a Switch-Stream header with related switching information.

30. The method according to claim 29, wherein the RTSP ANNOUNCE request message further includes an Real-time Transport Protocol (RTP)-Info header that contains RTSP-specific parameters of said second content data.

31. The method according to claim 28, wherein the first message comprises an RTSP PLAY response message that includes an RTP-Info header, the RTP-Info header containing RTSP-specific parameters of said second content data.

32. The method according to claim 27, further comprising, upon finishing delivery of said second content data, sending a second message to the terminal informing the terminal about a switch initiated by the media server from said second content data to said first content data.

33. The method according to claim 32, wherein the second message comprises an RTSP ANNOUNCE request message that includes a Server-Switch header with a value indicating said switch to said first content data and a Switch-Stream header with related switching information.

34. The method according to claim 27, wherein the first message includes Session Description Protocol (SDP) information related to said second content data, and further includes an SDP-Informed header with a value indicating that SDP information related to said second content data is different from that related to said first content data.

35. The method according to claim 27, further comprising:
establishing an RTSP session;
requesting said second content data from a Content/Service Provider server prior to sending the first message; and
tearing down the RTSP session with the Content/Service Provider server after finishing delivery of said second content data.

36. The method according to claim 27, wherein said first content data and said second content data each comprise at least one media stream.

37. The method according to claim 36, wherein said switch to said second content data is performed on a media stream basis and comprises at least one of switching to or adding a media steam associated with said second content data.

38. The method according to claim 37, wherein the first message includes a Require header with a value indicating said switching to or adding of said media stream.

39. The method according to claim 38, wherein the first message further includes a Switch-Stream header that comprises a Uniform Resource Locator for at least one of the media streams of said first content data or said second content data.

40. The method according to claim 36, wherein the at least one media stream of each of said first and second content data comprise either a video stream, an audio stream, or text stream.

41. A media server configured to initiate fast content switching in a communication network, said media server comprising:
a switching manager configured to generate a first message and to send that first message to a terminal that is receiving or requesting first content data, the first message informing the terminal about a switch initiated by the media server to second content data; and
a media manager configured to deliver said second content data to the terminal.

42. The media server according to claim 41, wherein the first message comprises an Real Time Streaming Protocol (RTSP) request message or an RTSP response message.

43. The media server according to claim 42:
wherein the first message comprises either an RTSP PLAY response message or comprises an RTSP ANNOUNCE request message that includes a Server-Switch header with a value indicating said switch to said second content data and a Switch-Stream header with related switching information; and
wherein the first message includes an Real-time Transport Protocol (RTP)-Info header that contains RTSP-specific parameters of said second content data.

44. The media server according to claim 41, wherein the switching manager is further configured to, upon finishing delivery of said second content data, send a second message to the terminal informing the terminal about a switch initiated by the media server from said second content data to said first content data.

45. The media server according to claim 41, wherein the first message includes Session Description Protocol (SDP) information related to said second content data, and further includes an SDP-Informed header with a value indicating that SDP information related to said second content data is different from that related to said first content data.

46. The media server according to claim 41, wherein the media manager is further configured to:
establish an RTSP session;
request said second content data from a Content/Service Provider server prior to sending the first message; and
tear down the RTSP session with the Content/Service Provider server after finishing delivery of said second content data.

47. The media server according to claim 41, wherein the switching manager is configured to perform said switch to said second content data on a media stream basis by at least one of switching to or adding a media steam associated with said second content data.

48. A method implemented by a terminal for fast content switching in a communication network, said method comprising:
receiving or requesting first content data from a media server;
receiving from the media server a first message that informs the terminal about a switch initiated by the media server to second content data; and
receiving from the media server and rendering said second content data.

49. The method according to claim 48:
wherein the first message comprises either an RTSP PLAY response message or comprises an RTSP ANNOUNCE request message that includes a Server-Switch header with a value indicating said switch to said second content data and a Switch-Stream header with related switching information; and
wherein the first message includes an Real-time Transport Protocol (RTP)-Info header that contains RTSP-specific parameters of said second content data.

50. A terminal configured for fast content switching in a communication network, said terminal comprising:
a media manager configured to receive or request first content data from a media server; and
a signal manager configured to receiving from the media server a first message that informs the terminal about a switch initiated by the media server to second content data;
wherein the media manager is further configured to receive from the media server and render said second content data.

51. A communication system comprising a terminal and a media server;
wherein the terminal includes a media manager configured to receive or request first content data from the media server;
wherein the media server includes a switching manager configured to generate a first message and to send that first message to the terminal, the first message informing the terminal about a switch initiated by the media server to second content data;
wherein the terminal includes a signal manager configured to receive said first message from the media server;
wherein the media server further includes a media manager configured to deliver said second content data to the terminal; and
wherein the terminal also includes a media manager configured to receive from the media server and render said second content data.

52. The communication system according to claim 51, further comprising a Content/Service Provider server that is configured to send said second content data to the media server, for delivery to the terminal.
